(19) United States
(12) Patent Application Publication
(10) Pub. No.: US 2024/0199963 A1
(43) Pub. Date: Jun. 20, 2024

(54) METHOD FOR PURIFYING HYDROCARBON FEEDSTOCK IN THE PRESENCE OF A SOLVENT AND USE THEREOF

(71) Applicant: TotalEnergies OneTech, Courbevoie (FR)

(72) Inventors: Thomas COUSTHAM, Ablon (FR); Christine LEGRAND, Lanquetot (FR); Hélène COULOMBEAU-LEROY, Montivilliers (FR)

(73) Assignee: TotalEnergies OneTech, Courbevoie (FR)

(21) Appl. No.: 18/288,944

(22) PCT Filed: May 2, 2022
(86) PCT No.: PCT/FR2022/050843

§ 371 Date: Oct. 30, 2023

(30) Foreign Application Priority Data
May 3, 2021 (FR) FR2104616

(51) Int. Cl. C10G 67/06; B01J 8/02; B01J 20/02; B01J 20/28; B01J 20/34

(52) U.S. Cl. CPC C10G 67/06; B01J 8/02; B01J 20/02; B01J 20/28011; B01J 20/34; C10G 2300/1014; C10G 2300/202; C10G 2300/4006; C10G 2300/4012; C10G 2300/70

(57) ABSTRACT

Disclosed is a method for purifying a composition containing a plastic pyrolysis oil, which method comprises treating with a strong base in the presence of an alcohol. The method is useful for reducing the concentration of heteroelements in said composition with a view to making it compatible for introduction as feedstock in conversion methods such as steam cracking, fluid catalytic cracking, catalytic hydrogenation or hydrocracking.

### TECHNICAL FIELD OF THE INVENTION

The present invention relates to a method for purifying hydrocarbon feedstock and subsequent use thereof in refining and petrochemical methods. The method according to the invention makes it possible to purify feedstocks containing plastic pyrolysis oils, in particular with a view to use thereof in a steam cracking method.

### Technological Background

The patent JP 3776335 discloses a method for dechlorination and denitrogenation of an oil coming from the catalytic or thermal cracking of plastics waste that is treated at various temperatures up to 425° ° C. for 30 minutes in the presence of an aqueous solution of an alkaline compound of an alkali metal or alkaline earth metal at a pH greater than or equal to 7. All hydroxides of natural non-radioactive alkali or alkaline earth metals are tested. The product of the reaction is next separated from the alkaline aqueous solution by liquid-liquid separation with ethyl ether.

Patent application WO 2012/069467 claims a method for eliminating siloxanes contained in a plastic pyrolysis oil by heat treatment at between 200 and 350° C. in the presence of an alkali metal hydroxide in the solid state or in solution. The use of calcium hydroxide at 5% by weight at 225° ° C. does not make it possible to obtain reduction of the siloxane content (table 5, p. 12 and lines 9 to 11, p. 13). At the end of the reaction, the pyrolysis oil is separated by distillation at reduced pressure.

The patent FI 128848 describes a method concatenation comprising a heat treatment of a plastic pyrolysis oil at least 200° C. in the presence of an alkaline aqueous solution. At the end of the reaction, the pyrolysis oil is separated from the alkaline aqueous phase. A final hydrotreatment makes it possible to obtain a steam-cracker feedstock that is optionally washed with an acid solution before it is introduced into the steam cracker.

Patent application WO 2020/02769 claims a method concatenation for purifying a composition comprising at least 20 ppm of chlorine. Numerous recyclable liquid wastes can be treated, including plastic pyrolysis oils. The method concatenation comprises a heat treatment of the feedstock in the presence of an alkali metal hydroxide in order to obtain a reduction of at least 50% of the chlorine content with respect to the feedstock, followed by a hydrotreatment in order to obtain a further reduction of at least 50% of the chlorine content.

These documents do not present any alternative means for purifying plastic pyrolysis oils.

### SUMMARY OF THE INVENTION

The invention aims to propose a method for purifying plastic pyrolysis oil facilitating purification thereof while limiting the quantity of strong base used and maintaining high reduction performances.

For this purpose, the invention relates to a method for reducing the concentration of heteroatoms of a composition comprising a plastic pyrolysis oil containing at least 20 ppm by mass of chlorine as measured in accordance with the standard ASTM D7359-18, comprising:
(a) putting said composition in contact with 0.1-50% by mass a strong base comprising an alkali or alkali earth metal cation, in the presence of a polar solvent comprising an alcohol function and/or an ether function, for at least one minute at a temperature of no more than 450° C.,
(b) separation between the strong base comprising the alkali or alkali earth metal cation and the product resulting from putting said composition in contact.

In step (a), the volume ratio of polar solvent to composition with the strong base can be from 1/99 to 95/10, from 1/99 to 90/10, from 2/98 to 90/10, from 2/98 to 85/15, from 2/98 to 80/20, from 2/98 to 75/25, from 2/98 to 70/30, from 2/98 to 65/35, from 2/98 to 60/40, from 2/98 to 55/45, from 2/98 to 50/50, from 2/98 to 45/55 or from 1/99 to 40/60, or in any interval defined by any of the aforementioned bounds.

The composition may further comprise a biomass pyrolysis oil such as Panicum virgatum, a tall oil, a waste food oil, an animal fat, a vegetable oil such as colza, canola, castor, palm or soya an oil extracted from an alga, an oil extracted from a fermentation of oleaginous microorganisms such as oleaginous yeasts, a pyrolysis oil of biomass such as a lignocellulosic biomass such as a wood, paper and/or cardboard pyrolysis oil, an oil obtained by pyrolysis of ground waste furniture, a pyrolysis oil of elastomers, for example of latex, optionally vulcanised, or tyres, as well as mixtures thereof.

The composition may comprise at least 2% by mass a plastic pyrolysis oil. The remainder can then be composed of no more than 98% by mass a diluent or solvent such as a hydrocarbon and/or one or more of the components listed above.

The separation between the strong base and the product resulting from the putting in contact at step (b) is advantageously done by (i) filtration, (ii) distillation, (iii) extraction by a solvent, (iv) washing with water, or (v) by combining two, three or four of steps (i) to (iv).

The putting in contact is preferably implemented for a period of 1 minute to 48 hours, preferably from 5 minutes to 2 hours, at a temperature of 50 to 450° C., preferably from 90 to 350° C., more preferentially from 150 to 350° C. and at an absolute pressure of 0.1 to 100 bar, preferably from 1 to 50 bar.

The polar solvent is ideally selected from (i) C1 to C4 alcohols, preferably from methanol, ethanol, propan-1-ol, propan-2-ol, butan-1-ol, butan-2-ol, 2-methylpropan-1-ol, ethylene glycol, propylene glycol, (ii) alcohols comprising an ether function, preferably diethylene glycol, triethylene glycol, polyethylene glycol, polypropylene glycol, and (iii) cyclic ethers, preferably tetrahydrofuran, 2-methyltetrahydrofuran, cyclopentylmethylether, tetrahydropyrane, 1,4-dioxane, eucalyptol and mixtures thereof.

A preferred strong base can be selected from LiOH, NaOH, CsOH, Ba(OH)₂, Na₂O, KOH, K₂O, Cao, Ca(OH) 2, MgO, Mg(OH)₂ and mixtures thereof.

The invention can also comprise an additional step wherein:
(c) the product resulting from the putting in contact of step (b) undergoes catalytic hydrogenation in one or two steps.

In the case where the catalytic hydrogenation takes place in two steps, step (c) is implemented in a first step (c-1) wherein the product resulting from the putting in contact is hydrogenated at a temperature of between 20 and 200° ° C., preferably between 30 and 90° C., in the presence of hydrogen at an absolute pressure of between 5 and 60 bar, preferably between 20 and 30 bar, and in the presence of a hydrogenation catalyst comprising Pd (0.1-10% by weight) and/or Ni (0.1-60% by weight) and/or NiMo (0.1-60% by weight), and in a second step (c-2) wherein the effluent resulting from step (c-1) is hydrogenated at a temperature of between 200 and 450° ° C., preferably between 200 and 340° ° C., in the presence of hydrogen at an absolute pressure of between 20 and 140 bar, preferably between 30 and 60 bar and in the presence of a hydrogenation catalyst comprising NiMo (0.1-60% by weight) and/or CoMo (0.1-60% by weight).

The product resulting from step (b) or the effluent resulting from step (c) is (d) preferably purified by passing over a solid adsorbent in order to reduce the content of at least one element from F, Cl, Br, I, O, N, S, Se, Si, P, As, Fe, Ca, Na, K, Mg and Hg and/or the water content.

The adsorbent can be implemented in regenerative or non-regenerative mode, at a temperature below 400° C., preferably below 100° C., more preferentially below 60° C., selected from: (i) a silica gel, (ii) a clay, (iii) a crushed clay, (iv) apatite, (v) hydroxyapatite and combinations thereof, (vi) an alumina, for example an alumina obtained by precipitating boehmite, a calcined alumina such as Ceralox® from Sasol, (vii) boehmite, (viii) bayerite, (ix) hydrotalcite, (x) a spinel such as Pural® or Puralox from Sasol, (xi) a promoted alumina, for example Selexsorb® from BASF, an acidic promoted alumina, an alumina promoted by a zeolite and/or by a metal such as Ni, Co, Mo or a combination of at least two of them, (xii) a clay treated by an acid such as Tonsil® from Clariant, (xiii) a molecular sieve in the form of an aluminosilicate containing an alkali or alkali earth cation, for example the sieves 3A, 4A, 5A, 13X, for example sold under the trade name Siliporite® from Ceca, (xiv) a zeolite, (xv) activated carbon, or the combination of at least two adsorbents, the adsorbent or the at least two adsorbents retaining at least 20% by weight, preferably at least 50% by weight of at least one element from F, Cl, Br, I, O, N, S, Se, Si, P, As, Fe, Ca, Na, K, Mg and Hg and/or water.

According to a preferred embodiment, the adsorbent is regeneratable, has a specific surface area of at least 200 m²/g and is implemented in a fixed-bed reactor at less than 100° C. with an HVV of 0.1 to 10 h⁻¹.

According to a supplementary embodiment, at least part of the product resulting from step (b) or of the effluent resulting from step (c) or (d) can be:
(e) treated in a steam cracker, and/or
(f) treated in a fluidised-bed catalytic cracker, and/or
(g) treated in a hydrocracker, and/or
(h) treated in a catalytic hydrogenation unit, and/or
(i) used as such or separated into usable flows for preparing fuels and combustibles such as LPG, petrol, diesel or heavy fuel oil and/or for preparing lubricants.

### Definitions

The Hourly Volume Velocity (HVV) is defined as the hourly volume of feedstock flow per unit catalytic volume and is expressed here in h⁻¹.

The terms “comprising” and “comprises” as used here are synonymous with “including”, “includes” or “contains”, “containing”, and are inclusive and without bounds and do not exclude additional unspecified characteristics, elements or method steps.

Specifying a numerical range without decimals includes all the integer numbers and, when appropriate, fractions thereof (for example, 1 to 5 can include 1, 2, 3, 4 and 5 when reference is made to a number of elements, and can also include 1.5, 2, 2.75 and 3.80 when reference is made to, for example, a measurement).

The specification of a decimal also comprises the decimal itself (for example, “from 1.0 to 5.0” includes 1.0 and 5.0). Any range of numerical values recited here also comprises any sub-range of numerical values mentioned above.

The expressions % by weight and % by mass have an equivalent meaning and refer to the proportion of the mass of a product referred to 100 g of a composition comprising it.

Unless indicated to the contrary, the measurements given in parts per million (ppm) are expressed by weight.

The acronym LPG corresponds to the expression liquefied petroleum gas and to the definition commonly accepted in industry that refers to a hydrocarbon cut essentially consisting of C3s (mainly propane) with a few C4 isomers including mainly n-butane and isobutene.

The expression “plastic pyrolysis oil” or “oil resulting from plastic pyrolysis” refers to the liquid products obtained at the end of a pyrolysis of thermoplastic, thermosetting or elastomer polymers, alone or in a mixture and generally in the form of waste. The pyrolysis method must be understood as a non-selective thermal cracking method. Pyrolysed plastic may be of any type. For example, the plastic to be pyrolysed may be polyethylene, polypropylene, polystyrene, a polyester, a polyamide, a polycarbonate, etc. These plastic pyrolysis oils contain paraffins, i-paraffins (iso-paraffins), dienes, alkynes, olefins, naphthenes and aromatics. Plastic pyrolysis oils also contain impurities such as chlorinated, oxygenated and/or silylated organic compounds, metals, salts, or compounds of phosphorus, sulfur and nitrogen.

The composition of the plastic pyrolysis oil is dependent on the nature of the pyrolysed plastic and consists essentially of hydrocarbons having from 1 to 50 carbon atoms and impurities.

The expression “MAV” (the acronym for “maleic anhydric value”) refers to the UOP326-82 method that is expressed in mg of maleic anhydride that react with 1 g of sample to be measured.

The expression “bromine number” corresponds to the quantity of bromine in grams that has reacted on 100 g of sample and can be measured in accordance with the ASTM D1159-07 method.

The expression “bromine index” is the number of milligrams of bromine that react with 100 g of sample and can be measured in accordance with the ASTM D2710 or ASTM D5776 methods.

The expression “polar solvent” within the meaning of the present patent application covers all chemical species, alone or in a mixture, able to solvate a composition comprising a plastic pyrolysis oil, and including at least one carbon-hydrogen, carbon-halogen, carbon-chalcogen or carbon-nitrogen covalent bond and having a non-zero dipolar moment. Acceptable polar solvents include compositions comprising hydrocarbon compounds that include heteroatoms in their molecular structure, for example (i) alcohols such as methanol and ethanol, and mixtures of alcohols resulting from fermentation, for example a mixture of isomers of butanol and a mixture of isomers of pentanol such as a fusel oil (ii) ethers, for example cyclopentylmethylether or 1,4-dioxane, (iii) sulfur compounds, for example thiophene or dimethylsulfoxide, (iv) nitrogen compounds, for example N,N-dimethylformamide, (v) halogenated compounds, for example dichloromethane or chloroform. It is understood that the term “polar solvent” within the meaning of the present definition specifically excludes water.

The term “solvent” includes the aforementioned “polar solvents” and apolar solvents, which comprise for example any type of linear, branched, cyclic and/or aromatic saturated or unsaturated hydrocarbon such as pentane, cyclohexane, oct-1-ene, toluene or p-xylene or certain other solvents with zero dipolar moment such as tetrachloromethane or carbon disulfide.

The boiling points as mentioned here are measured at pressure, atmospheric unless indicated to the contrary. An initial boiling point is defined as the temperature value as from which a first bubble of vapour is formed. A final boiling point is the highest temperature achievable during a distillation. At this temperature, no more vapour can be transported to a condenser. Determining the initial and final points has recourse to techniques known in the art and several methods adapted according to the distillation temperature range are applicable, for example NF EN 15199-1 (2020 version) or ASTM D2887 for measuring boiling points of petroleum fractions by gas chromatography, ASTM D7169 for heavy hydrocarbons, ASTM D7500, D86 or D1160 for distillates.

The concentration of metals in the hydrocarbon matrices can be determined by any known method. Acceptable methods include X-ray fluorescence (XRF) and inductively coupled plasma atomic emission spectrometry (ICP-AES). Analytic science specialists are able to identify the method most adapted to measuring each metal and each heteroelement according to the hydrocarbon matrix in question.

The particular characteristics, structures, properties and embodiments of the invention can be combined freely in one or more embodiments not specifically described here, as can be apparent to specialists in the treatment of plastic pyrolysis oils using their general knowledge.

### DESCRIPTION OF THE INVENTION

### Examples

The embodiments of the present invention are illustrated by the following non-limitative examples.

### Example 1: Purification of Two Plastic Pyrolysis Oils in the Presence of a Strong Base and of an Alcohol

Two different plastic pyrolysis oils, the physical and chemical characteristics of which are described in table 1 below, are used:

TABLE 1

| Pyrolysis oil | HPP1 | HPP2 |
|---|---|---|
| Density (g/ml) | 0.741 | 0.800 |
| Kinematic viscosity (15° C., mm²/s) | 0.70 | 2.1 |
| Distillation, initial point (° C.) | <36 | 69 |
| Distillation, 50% (° C.) | 131 | 214 |
| Distillation, final point (° C.) | 259 | 451 |
| Silicon (ppm by mass) | 72 | 82 |
| Chlorine (ppm by mass) | 50 | 96 |
| Oxygen (% by mass) | 1.6 | 0.87 |
| Nitrogen (ppm by weight) | 129 | 206 |
| Sulfur (ppm by weight) | 11 | 19 |

### Test Protocol:

A 1.5 L autoclave made from AISI-316L grade stainless steel equipped with mechanical stirring is loaded with a pyrolysis oil selected from HPP1 and HPP2, a strong base in the form of NaOH and optionally a solvent or water, according to the tests implemented (table 2). The sum of the volume of pyrolysis oil and of the volume of solvent or water introduced is equal to 600 mL at ambient temperature, without taking account of any effect of variation in volume during mixing thereof. The autoclave is closed and the gaseous roof in the autoclave is scavenged with nitrogen for 30 minutes. The autoclave is next heated under autogenous pressure under stirring at a speed of 400 to 1500 revolutions/minute at a temperature of 225° C. for a period of 30 minutes, once the target temperature has been reached. The temperature rise rate is fixed at 30° C./10 minutes.

TABLE 2

| | Test | | | | | | |
|---|---|---|---|---|---|---|---|
| | 1 | 2 | 3 | 4 | 5 | 6 | 7 |
| Pyrolysis oil | HPP1 | HPP2 | HPP2 | HPP2 | HPP2 | HPP2 | HPP2 |
| Solvent or water | — | — | Water | Water | Methanol | Ethanol | Iso-propanol |
| Solvent/feedstock ratio | — | — | 0.02 | 0.53 | 0.53 | 0.53 | 0.53 |
| Volume of solvent or water (mL) | 0 | 0 | 14 | 209 | 191 | 191 | 191 |
| Mass of NaOH (g) | 22.2 | 24.0 | 14.0 | 4.2 | 3.8 | 3.8 | 3.8 |
| Mass of pyrolysis oil (g) | 444.7 | 480.1 | 468.9 | 312.9 | 287.0 | 286.0 | 286.0 |
| Initial density (g/mL) | 741.2 | 800.2 | 800.2 | 800.2 | 800.2 | 800.2 | 800.2 |
| Final density (g/mL) | 746.4 | 792.8 | 793.1 | 793.7 | 792.9 | 793.0 | 792.2 |
| Final pressure in autoclave (bar) | 12 | 5 | 12 | 27 | 45 | 31 | 24 |

At the end of the reaction, the autoclave is cooled to ambient temperature and then the mixture is discharged and washed three times with water with, at each washing, a water/feedstock volume ratio=40/60, to eliminate the strong base residues and the water-soluble impurities. The resulting purified and washed pyrolysis oil is analysed to measure the proportion of residual impurities (table 3).

TABLE 3

| | Test | | | | | | |
|---|---|---|---|---|---|---|---|
| | 1 | 2 | 3 | 4 | 5 | 6 | 7 |
| Pyrolysis oil | HPP1 | HPP2 | HPP2 | HPP2 | HPP2 | HPP2 | HPP2 |
| Initial silicon (ppm weight) | 72 | 82 | 82 | 82 | 82 | 82 | 82 |
| Final silicon (ppm weight) | 2 | <2 | <2 | 17 | 2 | 3 | 3 |
| Silicon reduction (%) | 97 | >98 | >98 | 79 | 98 | 96 | 96 |
| Initial chlorine (ppm weight) | 50 | 96 | 96 | 96 | 96 | 96 | 96 |
| Final chlorine (ppm weight) | 17 | 14 | 16 | 16 | 15 | 17 | 22 |
| Chlorine reduction (%) | 66 | 85 | 83 | 83 | 84 | 82 | 77 |
| Initial oxygen (% weight) | 1.6 | 0.87 | 0.87 | 0.87 | 0.87 | 0.87 | 0.87 |
| Final oxygen (% weight) | 0.04 | 0.06 | 0.08 | 0.15 | 0.13 | n.d. | 0.08 |
| Oxygen reduction (%) | 98 | 93 | 91 | 83 | 85 | n.d. | 91 |
| Initial nitrogen (ppm weight) | 129.0 | 206.4 | 206.4 | 206.4 | 206.4 | 206.4 | 206.4 |
| Final nitrogen (ppm weight) | 16.6 | 31.1 | 31.7 | 47.8 | 31.5 | n.d. | 33.0 |
| Nitrogen reduction (%) | 87 | 85 | 85 | 77 | 85 | n.d. | 84 |

n.d.: not determined

A better reduction is observed, particularly for silicon and nitrogen, when the reaction is conducted in the presence of an alcohol (tests 5 to 7) compared with the use of water (test 4), at an almost equivalent concentration of soda (a little more concentrated when the soda is in solution in water).

An analysis of a few other elements and properties was implemented and is presented in table 4 below:

TABLE 4

| Test | HPP2 | 3 | 7 |
|---|---|---|---|
| Ca (mg/kg) | 0.3 | <0.25 | <0.25 |
| Fe (mg/kg) | 2.2 | 0.5 | 1.2 |
| Na (mg/kg) | <2.0 | <2.0 | <2.0 |
| P (mg/kg) | 1.6 | <0.25 | <0.25 |
| S (ppm weight) | 19.3 | 10.5 | 11 |
| S reduction (%) | — | 46 | 43 |
| MAV (mg of maleic anhydride/g | 13.9 | 12.8 | 14.7 |
| Bromium index (g of bromium/100 g) | 70 | 70 | 72 |

The data in table 4 show that the use of soda in the presence of an alcohol (isopropanol, test 7) gives results substantially equivalent to the use of concentrated soda in water (test 3), whereas advantageously 3.8 g of soda is used for 286 g of HPP2 feedstock in test 7 versus 14.0 g of soda for 468.9 g of HPP2 feedstock in test 3.

The speciation of the families of hydrocarbons made it possible to show that the treatment method using a strong base in the presence of alcohol did not significantly affect the composition profile of the plastic pyrolysis oil (table 5). Results presented in arbitrary units, relative values.

TABLE 5

| Test | HPP2 | 7 |
|---|---|---|
| n- and iso-paraffins | 45.3 | 45.2 |
| Olefins | 34.2 | 35 |
| Mono-naphthenes | 4.3 | 4.6 |
| Poly-naphthenes | 4.7 | 4.7 |
| Mono-aromatics | 9.8 | 10.9 |
| Di-aromatics | 0.58 | 0.62 |
| Tri-aromatics | 0.08 | 0.16 |

The pyrolysis oil may be either used as such or optionally dried on an adsorbent such as a molecular sieve or an anhydrous salt, for example Na₂SO₄, and is then distilled under reduced pressure in order to eliminate any trace of solid, for example strong base, absorbent residue, anhydrous/hydrated salt or gums.

Alternatively, the mixture directly coming from the autoclave could be distilled under reduced pressure to a pressure of 1 mbar and at a temperature of 200 to 250° ° C. to collect a purified pyrolysis oil as distillate and a residue comprising the strong base associated with impurities.

### Example 2: Hydrotreatment in Two Steps and Steam Cracking of the Product of Example 1

One of the seven purified and washed pyrolysis oils of example 1 can be hydrotreated in two steps in accordance with the following procedure:

The purified and washed pyrolysis oil can be introduced into a first hydrotreatment section (HDT1) essentially to hydrogenate the diolefins and is carried out in liquid phase. This step can comprise a plurality of reactors in series and/or parallel if guard reactors are used upstream or downstream of the first hydrogenation reactor. These guard reactors can make it possible to reduce the concentration of certain undesirable chemical species and/or elements such as chlorine, silicon and metals. Particularly undesirable metals include Na, Ca, Mg, Fe and Hg.

A second hydrotreatment section (HDT2) is dedicated to the hydrogenation of olefins and to demetallation (HDM), desulfurisation (HDS), denitrogenation (HDN) and deoxygenation (HDO). HDT2 is implemented in gaseous phase. This section consists of one or more reactors operated in series, in lead-lag or in parallel.

As the hydrotreatment reactions in the HDT1 and HDT2 sections are exothermic, quenching by cold hydrogen can be used to moderate the temperature rise and to control the reaction.

Isolated guard reactors, in lead-lag, in series and/or in parallel can be contemplated according to the nature and quantity of the contaminant in the flow to be treated.

Should the treatment of example 1 not make it possible to obtain sufficient reduction in impurities, guard reactors for eliminating chlorine and silicon can be operated in gaseous phase. Silicon can also be trapped on the top bed of a reactor of the HDT2 section or separately, upstream or downstream by treatment of the hot gases leaving the HDT2 section.

Chlorine and mercury can be separated by guard reactors in liquid or gaseous phase.

There can be intermediate quenching between the beds or between the reactors HDT1 and HDT2 or no quenching. In the latter case, recycling of part of the flow leaving HDT1 or HDT2 can be implemented to control the temperature. Strict temperature control in HDT1 must be implemented, in order to avoid blocking of the reactor and degradation of the catalytic hydrogenation conditions.

The operating pressure in each of the hydrotreatments HDT1 and HDT2 is 5-60 bar, preferably 20-30 bar for HDT1 and 20-120 bar, preferably 30-60 bar for HDT2, typically 30-40 bar for HDT2. Typical temperature range at the inlet of HDT1 at the start of the cycle (SOR: start of run): 150-200° C. The catalyst for HDT1 normally comprises Pd (0.1-10% weight) and/or Ni (0.1-60% weight) and/or NiMo (0.1-60% weight).

Typical temperature range at the inlet of HDT2 at the start of the cycle (SOR: start of run): 200-340° C. Typical temperature range at the outlet of HDT2 (SOR): 300-380° ° C., up to 450° C. The catalyst for HDT2 normally comprises an NiMo (any type of commercial catalyst for refining or petrochemistry application), potentially a CoMo in the very last beds at the bottom of the reactor (any type of commercial catalyst for refining or petrochemistry application).

The top bed of HDT2 should preferably be operated with an NiMo having a hydrogenating capability as well as a silicon trapping capability. A top bed of this type can be considered to be an adsorbent as well as a metal trap also having an HDN activity and a hydrogenating capability. An example of a top bed acceptable for this function comprises the commercially available NiMo catalysing adsorbents such as ACT971 or ACT981 from Axens or equivalent from Haldor Topsoe, Axens, Criterion, etc. It is possible to have two separate beds in an HDT2 reactor, with a quenching between the two beds or between the two reactors, if the two beds are in two distinct reactors, or no quenching at all. Ideally, the intermediate quenching must be implemented by means of cold effluent from HDT2 or by an addition of cold hydrogen, i.e. at a temperature generally ranging from 15 to 30° C., in order to control the HDT2 exotherm. A dilution by recycling of the hydrocarbon flow to the top bed of HDT2 is not recommended because of the increased risks of fouling the bed. The feedstock arriving on the HDT2 catalyst should be completely vaporised at all times, including in variable regime as is the case during start-ups. Sending liquid hydrocarbons to the top bed of an HDT2 reactor can cause fouling and an increase in the pressure difference between the inlet and outlet of said HDT2 reactor and lead to premature stoppage.

According to the metals present in the pyrolysis oil to be hydrotreated, a hydrodemetallation catalyst, for example commercial, can be added to the top bed of the HDT2 section in order to protect the lower catalytic beds from deactivation.

The hydrotreated pyrolysis oil leaving the HDT2 section can be used as it stands or fractionated according to distillation temperature ranges, to supply a steam cracker, an FCC, a hydrocracker, a catalytic reformer or a pool of fuels or combustibles such as LPG, petrol, jet fuel, diesel, fuel oil.

Alternatively, the treated pyrolysis oil leaving the HDT2 section undergoes an additional purification step passing over a capture mass such as an adsorbent, for example (i) a silica gel, (ii) a clay, (iii) a crushed clay, (iv) apatite, (v) hydroxyapatite and combinations thereof, (vi) an alumina, for example an alumina obtained by precipitating boehmite, a calcined alumina Ceralox® from Sasol, (vii) boehmite, (viii) bayerite, (ix) hydrotalcite, (x) a spinel such as Pural® or Puralox from Sasol, (xi) a promoted alumina, for example Selexsorb® from BASF, an acidic promoted alumina, an alumina promoted by a zeolite and/or by a metal such as Ni, Co, Mo or a combination of at least two of them, (xii) a clay treated with an acid such as Tonsil® from Clariant, (xiii) a molecular sieve in the form of an aluminosilicate containing an alkali or alkali earth cation, for example the sieves 3A, 4A, 5A, 13X, for example sold under the trade name Siliporite® from Ceca, (xiv) a zeolite, (xv) activated carbon, or the combination of at least two adsorbents, the adsorbent or the at least two adsorbents retaining at least 20% by weight, preferably at least 50% by weight of at least one element from F, Cl, Br, I, O, N, S, Se, Si, P, As, Fe, Ca, Na, K, Mg and Hg and/or water. Ideally, the adsorbent is regeneratable, has a specific surface area of at least 200 m²/g and is implemented in a fixed-bed reactor at less than 100° C. with an HVV of 0.1 to 10 h⁻¹.

1. Method for reducing the concentration of heteroatoms of a composition comprising a plastic pyrolysis oil containing at least 20 ppm by mass of chlorine as measured in accordance with the standard ASTM D7359-18, comprising:
(a) putting said composition in contact with 0.1-50% by mass a strong base comprising an alkali or alkali earth metal cation, in the presence of a polar solvent comprising an alcohol function and/or an ether function, for at least one minute at a temperature of no more than 450° C.,
(b) separation between the strong base comprising the alkali or alkali earth metal cation and the product resulting from putting said composition in contact.

2. Method according to claim 1, wherein the composition further comprises a biomass pyrolysis oil such as Panicum virgatum, a tall oil, a waste food oil, an animal fat, a vegetable oil such as colza, canola, castor, palm or soya oil, an oil extracted from an alga, an oil extracted from a fermentation of oleaginous microorganisms such as oleaginous yeasts, a pyrolysis oil of biomass such as a lignocellulosic biomass such as a wood, paper and/or cardboard pyrolysis oil, an oil obtained by pyrolysis of ground waste furniture, a pyrolysis oil of elastomers, for example of latex, optionally vulcanised, or tyres, as well as mixtures thereof.

3. Method according to claim 1, wherein the separation between the strong base and the product resulting from the putting in contact at step (b) is advantageously done by (i) filtration, (ii) distillation, (iii) extraction by a solvent, (iv) washing with water, or (v) by combining two, three or four of steps (i) to (iv).

4. Method according to claim 1, wherein the putting in contact is implemented for a period of 1 minute to 48 hours, preferably from 5 minutes to 2 hours, at a temperature of 50 to 450° C., preferably from 90 to 350° C., more preferentially from 150 to 350° C. and at an absolute pressure of 0.1 to 100 bar, preferably from 1 to 50 bar.

5. Method according to claim 1, wherein the polar solvent is selected from (i) C1 to C4 alcohols, preferably from methanol, ethanol, propan-1-ol, propan-2-ol, butan-1-ol, butan-2-ol, 2-methylpropan-1-ol, ethylene glycol, propylene glycol, (ii) alcohols comprising an ether function, preferably diethylene glycol, triethylene glycol, polyethylene glycol, polypropylene glycol, and (iii) cyclic ethers, preferably tetrahydrofuran, 2-methyltetrahydrofuran, cyclopentylmethylether, tetrahydropyrane, 1,4-dioxane, eucalyptol and mixtures thereof.

6. Method according to claim 1, wherein the strong base is selected from LiOH, NaOH, CsOH, Ba(OH)₂, NazO, KOH, K₂O, CaO, Ca(OH)₂, MgO, Mg(OH)₂ and mixtures thereof.

7. Method according to claim 1, wherein:
(c) the product resulting from the putting in contact of step (b) undergoes catalytic hydrogenation in one or two steps.

8. Method according to claim 7, wherein the catalytic hydrogenation of step (c) is implemented in a first step (c-1) wherein the product resulting from the putting in contact is hydrogenated at a temperature of between 20 and 200° ° C., preferably between 30 and 90° C., in the presence of hydrogen at an absolute pressure of between 5 and 60 bar, preferably between 20 and 30 bar, and in the presence of a hydrogenation catalyst comprising Pd (0.1-10% by weight) and/or Ni (0.1-60% by weight) and/or NiMo (0.1-60% by weight), and in a second step (c-2) wherein the effluent resulting from step (c-1) is hydrogenated at a temperature of between 200 and 450° C., preferably between 200 and 340° ° C., in the presence of hydrogen at an absolute pressure of between 20 and 140 bar, preferably between 30 and 60 bar and in the presence of a hydrogenation catalyst comprising NiMo (0.1-60% by weight) and/or CoMo (0.1-60% by weight).

9. Method according to claim 1, wherein the product resulting from step (b) or the effluent resulting from step (c) is (d) purified by passing over a solid adsorbent in order to reduce the content of at least one element from F, Cl, Br, I, O, N, S, Se, Si, P, As, Fe, Ca, Na, K, Mg and Hg and/or the water content.

10. Method according to claim 9, wherein the adsorbent is implemented in regenerative or non-regenerative mode, at a temperature below 400° ° C., preferably below 100° C., more preferentially below 60° C., selected from: (i) a silica gel, (ii) a clay, (iii) a crushed clay, (iv) apatite, (v) hydroxyapatite and combinations thereof, (vi) an alumina, for example an alumina obtained by precipitating boehmite, a calcined alumina, (vii) boehmite, (viii) bayerite, (ix) hydrotalcite, (x) a spinel, (xi) a promoted alumina, an acidic promoted alumina, an alumina promoted by a zeolite and/or by a metal such as Ni, Co, Mo or a combination of at least two of them, (xii) a clay treated by an acid, (xiii) a molecular sieve in the form of an aluminosilicate containing an alkali or alkali earth cation, for example the sieves 3A, 4A, 5A, 13X, (xiv) a zeolite, (xv) an activated carbon, or the combination of at least two adsorbents, the adsorbent or the at least two adsorbents retaining at least 20% by weight, preferably at least 50% by weight of at least one element from F, Cl, Br, I, O, N, S, Se, Si, P, As, Fe, Ca, Na, K, Mg and Hg and/or water.

11. Method according to claim 10, wherein the adsorbent is regeneratable, has a specific surface area of at least 200 m²/g and is implemented in a fixed-bed reactor at less than 100° C. with an HVV of 0.1 to 10 h⁻¹.

12. Method according to claim 1, wherein at least part of the product resulting from step (b) or of the effluent resulting from step (c) or (d) is:
(e) treated in a steam cracker, and/or
(f) treated in a fluidised-bed catalytic cracker, and/or
(g) treated in a hydrocracker, and/or
(h) treated in a catalytic hydrogenation unit, and/or
(i) used as such or separated into usable flows for preparing fuels and combustibles such as LPG, petrol, diesel or heavy fuel oil and/or for preparing lubricants.
